(19) United States
(12) Patent Application Publication
(10) Pub. No.: US 2022/0189408 A1
(43) Pub. Date: Jun. 16, 2022

(54) ELECTRONIC DEVICE AND METHOD FOR CONTROLLING REFRESH RATE OF DISPLAY

(71) Applicant: Samsung Electronics Co., Ltd., Gyeonggi-do (KR)

(72) Inventors: Jeonggyu JO, Gyeonggi-do (KR); Junghoon PARK, Gyeonggi-do (KR); Hyunwoo SIM, Gyeonggi-do (KR); Seunggoo KANG, Gyeonggi-do (KR); Soon PARK, Gyeonggi-do (KR)

(21) Appl. No.: 17/420,786

(22) PCT Filed: Jun. 10, 2021
(86) PCT No.: PCT/KR2021/007260

§ 371 Date: Jul. 6, 2021

(30) Foreign Application Priority Data
Jul. 9, 2020 (KR) 10-2020-0084485

(51) Int. Cl. G09G 3/3266; G09G 3/3275; G09G 3/00

(52) U.S. Cl. CPC G09G 3/3266; G09G 3/3275; G09G 2360/12; G09G 2380/02; G09G 2354/00; G09G 3/035

(57) ABSTRACT

According to certain embodiments, an electronic device comprises: a display; a memory; and a processor operatively connected to the display and the memory, wherein the processor is configured to: based on a user interface displayed on the display, determine a first refresh rate for a first area of the display, and a second refresh rate for a second area of the display; and transfer a first signal based on the first refresh rate and a second signal based on the second refresh rate to the display; and wherein the first signal causes the first area to be refreshed at the first refresh rate, the second signal causes the second area to be refreshed at the second refresh rate.

### CROSS-REFERENCE TO RELATED APPLICATION(S)

This application is a National Phase Entry of PCT International Application No., PCT/KR2021/007260, which was filed on Jun. 10, 2021 and claims priority under 35 U.S.C. 119 to Korean Patent Application No. 10-2020-0084485, filed on Jul. 9, 2020, in the Korean Intellectual Property Office, the disclosure of which is herein incorporated by reference in its entirety.

### TECHNICAL FIELD

Certain embodiments of the disclosure relate to a method and a device for controlling a display refresh rate.

### BACKGROUND ART

Development of digital technologies has been followed by widespread use of various types of electronic devices such as a personal digital assistant (PDA), an electronic wallet, a smartphone, a tablet personal computer, and a wearable device. Such electronic devices are designed to efficiently use limited resources (for example, processes, memories, or electric power). In order to support and enhance functions of electronic devices, hardware parts and/or software parts of electronic devices are continuously improved.

The above information is presented as background information only to assist with an understanding of the disclosure. No determination has been made, and no assertion is made, as to whether any of the above might be applicable as prior art with regard to the disclosure.

### Technical Problem

Certain embodiments may provide a method and a device for controlling each area of a display so as to operate at a different refresh rate.

### Technical Solution

According to certain embodiments, an electronic device comprises: a display; a memory; and a processor operatively connected to the display and the memory, wherein the processor is configured to: based on a user interface displayed on the display, determine a first refresh rate for a first area of the display, and a second refresh rate for a second area of the display; and transfer a first signal based on the first refresh rate and a second signal based on the second refresh rate to the display; and wherein the first signal causes the first area to be refreshed at the first refresh rate, the second signal causes the second area to be refreshed at the second refresh rate.

According to certain embodiments, a display device comprises: a display panel; and a display driver integrated circuit including a driver circuit electrically connected to the display panel, and wherein the driver circuit comprises: a driver electrically connected to the display panel; a first synchronization module configured to synchronize a signal transmitted to the driver circuit according to a first refresh rate for a first area of the display panel; and a second synchronization module configured to synchronize a signal transmitted to the driver circuit according to a second refresh rate for a second area of the display panel.

According to certain embodiments, a method comprises: based on a user interface displayed on a display of the electronic device, determining a first refresh rate for a first area of the display, and a second refresh rate for a second area of the display; and transferring a first signal based on the first refresh rate and a second signal based on the second refresh rate to the display to control the display, wherein the first signal causes the first area to be refreshed at the first refresh rate, the second signal causes the second area to be refreshed at the second refresh rate.

### Advantageous Effects

According to certain embodiments, each area of a display may be controlled to operate at a different refresh rate, thereby reducing power consumed by the electronic device.

According to certain embodiments, each area of a display may be controlled to operate at a different refresh rate through improvement of the hardware structure of the display, thereby improving the flickering phenomenon resulting from a frequency change.

According to certain embodiments, the lifespan of a display panel may be increased by improving the hardware structure of the display.

### BRIEF DESCRIPTION OF THE DRAWINGS

FIG. 1 is a block diagram of an electronic device in a network environment according to certain embodiments;

FIG. 2 is a diagram illustrating an example of controlling a display of an electronic device for each area of the display according to certain embodiments;

FIG. 3A is a diagram illustrating a configuration for controlling an area-specific refresh rate of a display of an electronic device according to certain embodiments;

FIG. 3B is a configuration diagram of a driver circuit and a display panel according to certain embodiments;

FIG. 3C is a diagram illustrating another configuration for controlling an area-specific refresh rate of a display of an electronic device according to certain embodiments;

FIG. 4A to FIG. 4C are diagrams illustrating a configuration for controlling an area-specific refresh rate of a display of an electronic device according to certain embodiments;

FIG. 5 is a diagram illustrating a configuration for controlling an area-specific refresh rate of a display of a first type flexible electronic device according to certain embodiments;

FIG. 6A and FIG. 6B are diagrams illustrating a configuration for controlling an area-specific refresh rate of a display of a second type flexible electronic device according to certain embodiments;

FIG. 7 is a flowchart illustrating an operation method of an electronic device according to certain embodiments;

FIG. 8 is a flowchart illustrating a method for controlling a refresh rate of an electronic device according to certain embodiments;

FIG. 9 is a flowchart illustrating a method for controlling a display refresh rate of an electronic device according to certain embodiments; and

FIG. 10 is a diagram illustrating a configuration for controlling an area-specific refresh rate of a display of a rollable electronic device according to certain embodiments.

### MODE FOR CARRYING OUT THE DISCLOSURE

The display (or display panel) of an electronic device may include an organic light-emitting diode (OLED). OLEDs may be classified into passive matrix types and active matrix types according to the driving scheme. An active matrix-type OLED (AMOLED) may have multiple pixels disposed in a matrix type such that, if a scan signal, a data signal, and driving power are supplied thereto, selected pixels emit light, thereby displaying images.

When at least 15 frames/second of a moving object are presented to the human eye, the human eye perceives them as continuous motion without detecting flickering (for example, a flicker). Therefore, electronic devices may generally drive displays at a frequency of 60 Hz.

When displaying a game screen or playing a moving image or during a touch, an electronic device may drive the display at a higher frequency (for example, 90 Hz or 120 Hz) higher than 60 Hz. Although the higher driving frequency consumes more power, the higher driving frequency may have benefits. For example, in a game, content changes very rapidly and a higher frequency may make the rapid changes appear continuous. Alternatively, when displaying a still image (for example, a picture) or a document, an electronic device may drive the display at a lower frequency. The higher the driving frequency of the display, the more electric power may be consumed by the electronic device.

However, with multi-window displays, a game can be displayed in a window consuming only a portion of the display. Additionally, during a touch, the portion that is touched and relevant to the user may be a very small part of the display. When the electronic device drives the entire area of the display at the same frequency, a dilemma occurs. If the full power needed to use the higher driving frequency is expended, even though only a small portion of the screen actually needs the higher frequency. Alternatively, if a lower frequency is used, the portion of the display appears slow.

Therefore, according to certain embodiments, each area of a display may be refreshed at a different rate. Thus, allowing a better user experience while reducing power consumption.

The electronic device according to certain embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

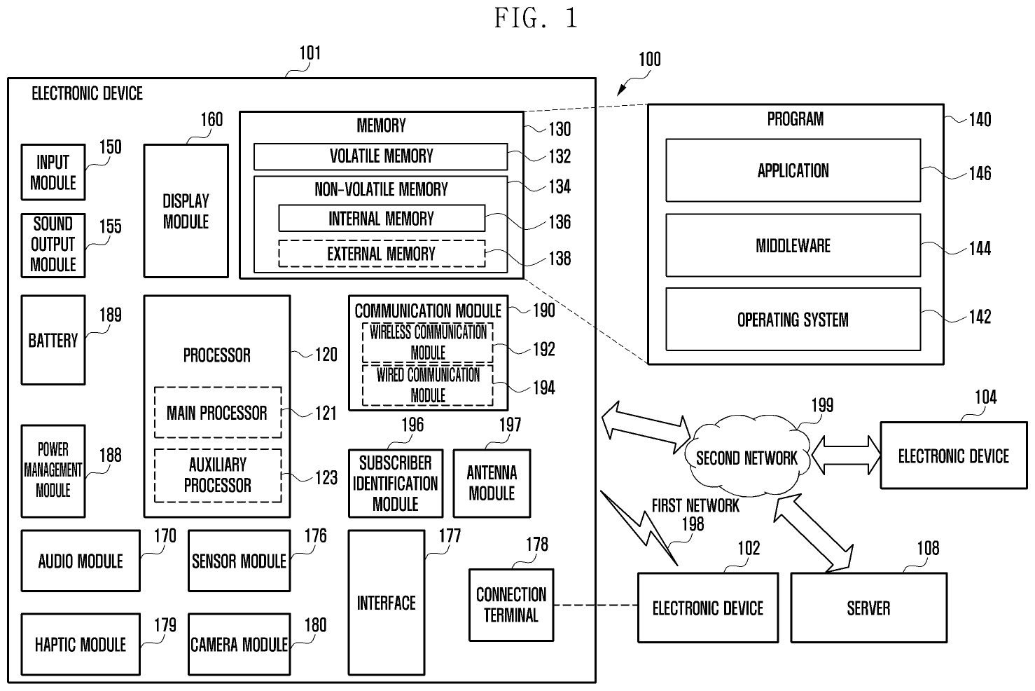

FIG. 1 is a block diagram illustrating an electronic device 101 in a network environment 100 according to certain embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input 1module 150, a sound output 1module 155, a display 1module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the 11connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input 1module 150 may receive a command or data to be used by another component (e.g., the processor 120) of the electronic device 101, from the outside (e.g., a user) of the electronic device 101. The input 1module 150 may include, for example, a microphone, a mouse, a keyboard, a key (e.g., a button), or a digital pen (e.g., a stylus pen).

The sound output 1module 155 may output sound signals to the outside of the electronic device 101. The sound output 1module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 1module 160 may visually provide information to the outside (e.g., a user) of the electronic device 101. The display 1module 160 may include, for example, a display, a hologram device, or a projector and control circuitry to control a corresponding one of the display, hologram device, and projector. According to an embodiment, the display 1module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input 1module 150, or output the sound via the sound output 1module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

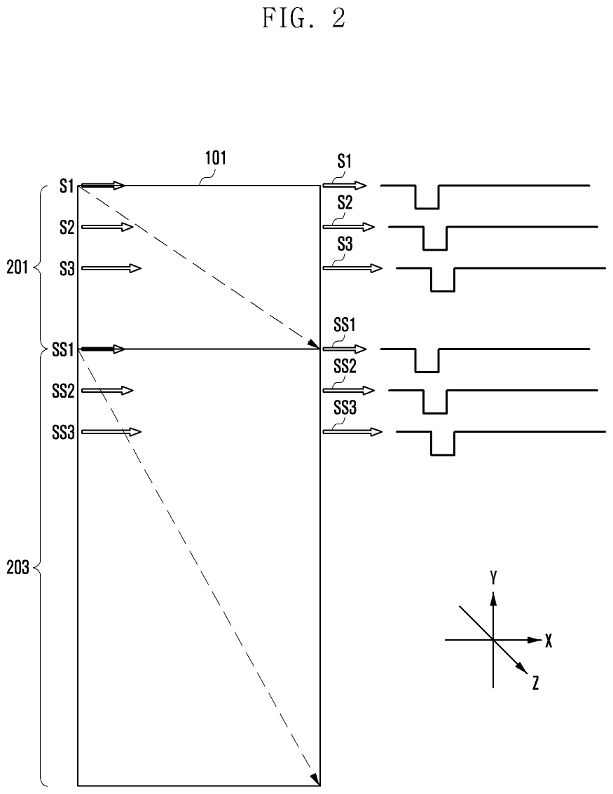

FIG. 2 is a diagram illustrating an example of controlling a display of an electronic device for each area of the display according to certain embodiments. The display can have two areas 201 and 203. First area 201 and the second area 203 can have different refresh rates by being individually controlled by different scan signals. For example, the first area 201 can be controlled by scan signals S1, S2, S3, while the second area 203 can be controlled by scan signals SS1, SS2, SS3.

Referring to FIG. 2, the electronic device 101 according to certain embodiments may determine a refresh rate of a display (e.g., the display module 160 in FIG. 1). The display module 160 of the electronic device 101 may be divided into a first area 201 and a second area 203. For example, the positions or the sizes of the first area 201 and the second area 203 may be determined in consideration of user usability. The display module 160 may include a display panel and a display driver integrated circuit (DDI). The display panel may include multiple pixels arranged in a matrix type, and a scan signal line and a data signal line corresponding to the multiple pixels may be connected to the display driver integrated circuit.

The display driver integrated circuit may transfer a scan signal or a data signal to the display panel according to a sequence of signals S1, S2, S3, . . . , SS1, SS2, and SS3, so as to control the entire area of the display panel. The scan signal may be sequentially transferred from the top to the bottom in the z-axis (e.g., the dotted arrow) direction without the distinction between the first area 201 and the second area 203.

However, the first scan signal (or a first data signal) can correspond to the first area 201 and a second scan signal (or a second data signal) can correspond to the second area 203. The first data signal and the second data signal are transferred to the display panel. Therefore, the first area 201 and the second area 203 can be individually controlled as separate display areas. The display driver integrated circuit may transfer a first scan signal (e.g., signals S1, S2, S3, . . . ) to the display panel corresponding to the first area 201 according to a control command of a processor (e.g., the processor 120 in FIG. 1). The display driver integrated circuit may transfer a second scan signal (e.g., signals SS1, SS2, SS3, . . . ) to the display panel corresponding to the second area 203, so as to control a refresh rate of the display module 160. The electronic device 101 may configure a refresh rate of the first area 201 and a refresh rate of the second area 203 to be the same or be different from each other.

An image (or video) may be generated by continuous movement of still pictures (or frames). The refresh rate may imply the number of times the display module 160 displays a frame on a screen in one second, and in other words, may be a numerical value indicating how many scenes the display module can display in one second. The refresh rate uses, as a unit, Hertz (Hz) implying the number of repetitions per second. For example, a display having a 60 Hz refresh rate may imply that the display displays a screen through 60 times in one second. As a similar concept, frames per second (FPS) is mainly used for a source (e.g., software) of an image, and Hertz is a concept of frequency of a repeated cycle, and thus may be used for hardware of a display. Hertz, as described above, may imply a refresh rate or an operating frequency of a display.

Based on a user interface to be displayed, the electronic device 101 may determine the refresh rate of the first area 201 and the second area 203. For example, the user interface can include a video at the first area 201, and includes a still image at the second area 203. The electronic device 101 may set a 60 Hz refresh rate (first refresh rate) for the first area 201, and set a 30 Hz refresh rate for the second area 203. Being based on the user interface may imply being based on a frame rate of a displayed image, the type of display data, the type of application and/or name of the application. The type of displayed data can include one of a moving image, a still image, or text. the type of application can include one of a media player, a game, a camera, a browser, or a message.

The display driver integrated circuit may transfer a first scan signal (e.g., signals S1, S2, S3, . . . ) to the first area 201, and transfer a second scan signal to the second area 203. The display panel may display a video on the first area 201 at the first refresh rate, and display a still image or text on the second area 203 at the second refresh rate.

The first refresh rate may be identical to, lower than, or higher than the second refresh rate. In the diagram, the display module 160 is illustrated to be divided into two areas (e.g., the first area 201 and the second area 203), but the number of separate areas may exceed two. Furthermore, in the diagram, the first area 201 and the second area 203 are illustrated to have different sizes, but the sizes of the first area 201 and the second area 203 may be the same.

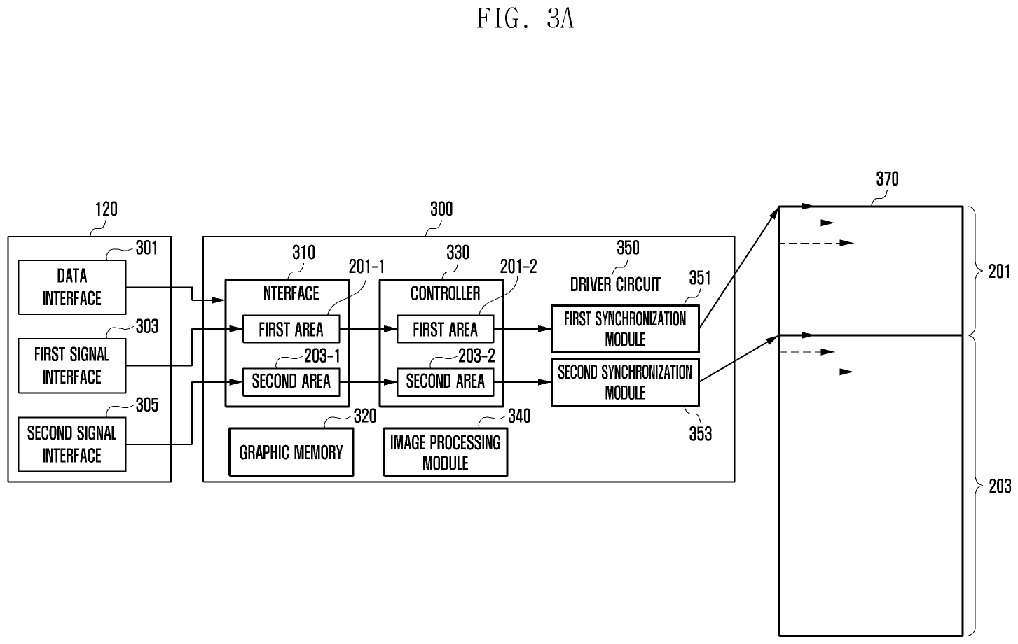

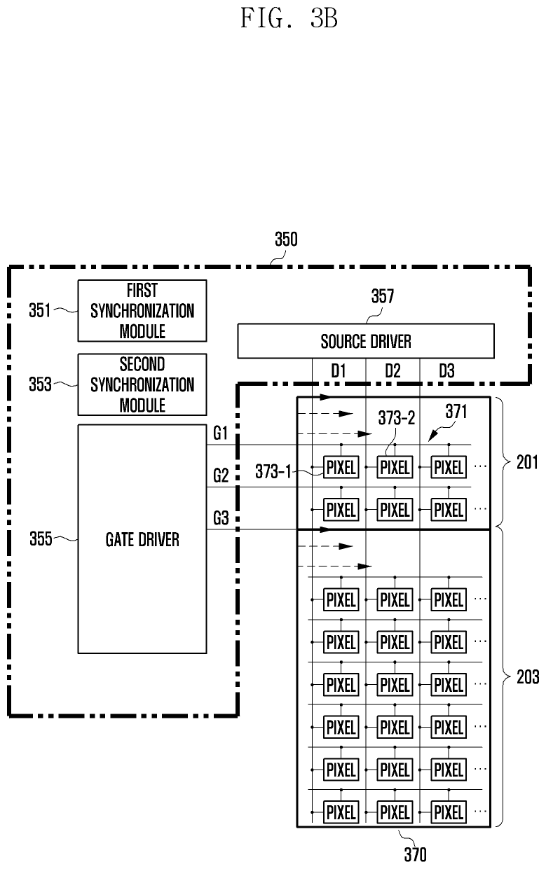

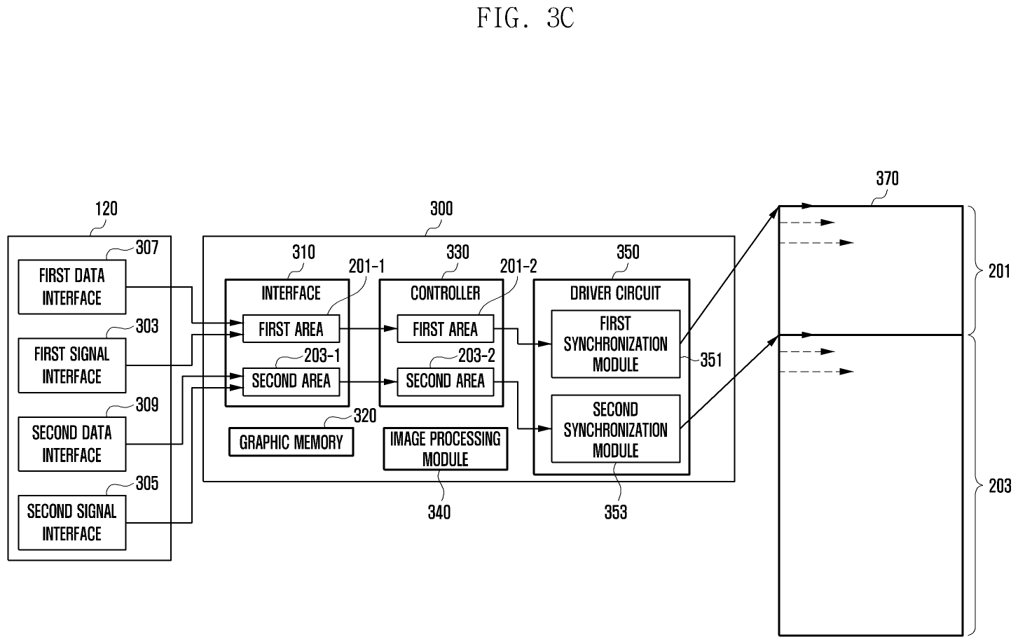

FIG. 3A is a diagram illustrating a configuration for controlling an area-specific refresh rate of a display of an electronic device according to certain embodiments.

Referring to FIG. 3A, an electronic device (e.g., the electronic device 101 in FIG. 1) according to certain embodiments may include a processor 120, a display driver integrated circuit 300, and a display panel 370. The processor 120 may include a data interface 301, a first signal interface 303, and a second signal interface 305.

The data interface 301 may transmit image data of a user interface for display on the display panel 370 to the DDIC 300. The data interface 301 may correspond to a transfer block of a mobile industry processor interface (MIPI). As another example, the data interface 301 may correspond to a transmission block of a mobile industry processor interface (MDDI) or a transmission block of a serial peripheral interface bus (SPI). The first signal interface 303 may transmit a first signal to the display driver integrated circuit 300 corresponding to the first area 201 of the display panel 370. The first signal (or a tearing effect (TE) signal) is a signal (e.g., frequency configuration, frequency start, or frequency end) related to a display operating frequency corresponding to the first area 201, and may include a first refresh rate (or a display operating frequency) corresponding to a first area 201-1. The second signal interface 305 may transmit a second signal to the display driver integrated circuit 300 corresponding to the second area 203 of the display panel 370. The second signal is a signal (e.g., frequency configuration, frequency start, or frequency end) related to a display operating frequency corresponding to a second area 203-1, and may include a second refresh rate corresponding to the second area 203-1.

The processor 120 may generate a user interface to be displayed on the display panel 370, and determine a refresh rate, based on the generated user interface. The user interface may include text or an image so as to correspond to the first area 201 of the display panel 370, and include a video so as to correspond to the second area 203 of the display panel 370. Based on the user interface, the electronic device 101 may use a 30 Hz refresh rate (first refresh rate) to correspond to the first area 201, and use a 60 Hz refresh rate (second refresh rate) to correspond to the second area 203. The processor 120 may include the configured first refresh rate in the first signal and transmit the signal to the display driver integrated circuit 300, and may include the configured second refresh rate in the second signal and transmit the signal to the display driver integrated circuit 300.

The display driver integrated circuit 300 may include an interface 310, a graphic memory 320, a controller 330, an image processing module 340, or a driver circuit 350. The interface 310 may receive image data from the processor 120. The interface 310 may include a reception block of a MIPI. The image data may include still image data or moving image data (or video data). The interface 310 may receive the first signal corresponding to the first area 201-1 and the second signal corresponding to the second area 203-1 from the processor 120. The interface 310 may transfer image data received from the processor 120 to the graphic memory 320 or the controller 330.

The graphic memory 320 may store image data received through the interface 310. For example, the graphic memory 320 may buffer received image data before transmitting the same to another element (e.g., the image processing module 340 or the driver circuit 350). According to an embodiment, the graphic memory 320 may transmit stored image data to the image processing module 340. The image processing module 340 may improve the quality of image data by processing the image data. According to certain embodiments, the display driver integrated circuit 300 may include at least one image processing module 340. According to an embodiment, the image processing module 340 may transfer processed image data to the driver circuit 350.

The controller 330 may control an operation of the display driver integrated circuit 300. The controller 330 may include a timing controller for synchronizing a signal when image data is processed. According to an embodiment, the controller 330 may transfer, to the driver circuit 350, a first control signal allowing an operation having a first refresh rate correspondingly to a first area 201-2, and transfer, to the driver circuit 350, a second control signal allowing an operation having a second refresh rate correspondingly to the second area 203-2.

The driver circuit 350 may be operated according to a control of the controller 330. The driver circuit 350 may include a first synchronization module 351, a second synchronization module 353, or a driver (not illustrated, refer to FIG. 3B). The first synchronization module 351 may synchronize a signal transmitted from the driver, according to a first refresh rate corresponding to the first area 201. The second synchronization module 353 may synchronize a signal transmitted from the driver, according to a second refresh rate corresponding to the second area 203, based on a signal synchronized by the first synchronization module 351. If the first refresh rate and the second refresh rate differ from each other, signals may be synchronized according to different standards. The driver circuit 350 may include individual synchronization modules corresponding to different areas (e.g., the first area 201 and the second area 203) of the display panel 370 to operate the areas at different refresh rates.

The driver may include a gate driver or a source driver (or a data driver). The gate driver may scan and operate scan lines connected to pixels of the display panel 370. The gate driver may transmit a scan signal through the scan lines. The gate driver may transmit a first scan signal so as to correspond to the first area 201 of the display panel 370, and transmit a second scan signal so as to correspond to the second area 203 of the display panel 370. The source driver may operate data lines connected to pixels of the display panel 370. The source driver may transmit a first data signal so as to correspond to the first area 201 of the display panel 370, and transmit a second data signal so as to correspond to the second area 203 of the display panel 370.

The first synchronization module 351 may synchronize a first scan signal and a first data signal for operating the first area 201 of the display panel 370, according to a first refresh rate configured by the processor 120. The second synchronization module 353 may synchronize a second scan signal and a second data signal for operating the second area 203 of the display panel 370, according to a second refresh rate configured by the processor 120. The second synchronization module 353 may change the signals synchronized by the first synchronization module 351, to synchronize a second scan signal and a second data signal according to the second refresh rate.

The display panel 370 may include multiple pixels, and each of the pixels may be connected to a scan line connected to the gate driver and a data line connected to the source driver. The display panel 370 may be operated by a scan signal provided by the gate driver and a data signal provided by the source driver. In the display panel 370, the first area 201 may be operated by a first scan signal and a first data signal corresponding to the first area 201, and the second area 203 may be operated by a second scan signal and a second data signal corresponding to the second area 203.

FIG. 3B is a configuration diagram of a driver circuit and a display panel according to certain embodiments. Referring to FIG. 3B, the driver circuit 350 may include a first synchronization module 351, a second synchronization module 353, a gate driver 355, and a source driver 357. The display panel 370 may include multiple pixels 371. Each of the pixels (e.g., the pixel 373-1 and the pixel 373-2) included in the display panel 370 may be connected to a scan line G1, G2, or Gn connected to the gate driver 355, and a data line D1, D2, or D3 connected to the source driver 357.

The gate driver 355 may transmit a first scan signal through a scan line so as to correspond to the first area 201 of the display panel 370 and transmit a second scan signal so as to correspond to the second area 203 of the display panel 370. The source driver 357 may transmit a first data signal through a data line so as to correspond to the first area 201 of the display panel 370 and transmit a second data signal so as to correspond to the second area 203 of the display panel 370.

FIG. 3C is a diagram illustrating another configuration for controlling an area-specific refresh rate of a display of an electronic device according to certain embodiments.

Referring to FIG. 3C, an electronic device (e.g., the electronic device 101 in FIG. 1) according to certain embodiments may include a processor 120, a display driver integrated circuit 300, and a display panel 370. The processor 120 may include a first data interface 307, a first signal interface 303, a second data interface 309, and a second signal interface 305. The first data interface 307 may transmit first image data of a user interface to be displayed on the first area 201 of the display panel 370 to the display driver integrated circuit 300. The second data interface 309 may transmit second image data of a user interface to be displayed on the second area 203 of the display panel 370 to the display driver integrated circuit 300. Each of the first data interface 307 and the second data interface 309 may correspond to a transfer block of an RGB interface.

The first signal interface 303 may transmit a first signal to the display driver integrated circuit 300 correspondingly to the first area 201 of the display panel 370. The first signal is a frequency change signal, and may include a first refresh rate (or a display operating frequency) corresponding to the first area 201. The second signal interface 305 may transmit a second signal to the display driver integrated circuit 300 correspondingly to the second area 203 of the display panel 370. The second signal may include a second refresh rate corresponding to the second area 203.

The display driver integrated circuit 300 may include an interface 310, a graphic memory 320, a controller 330, an image processing module 340, or a driver circuit 350. The interface 310 may receive image data from the processor 120. The interface 310 may include a reception block of an RGB interface.

FIG. 3C illustrates the same elements as those of FIG. 3A, differing only in that the first data interface 307 and the second data interface 309 are used instead of the data interface 301 illustrated in FIG. 3A. Therefore, a detailed description may be omitted.

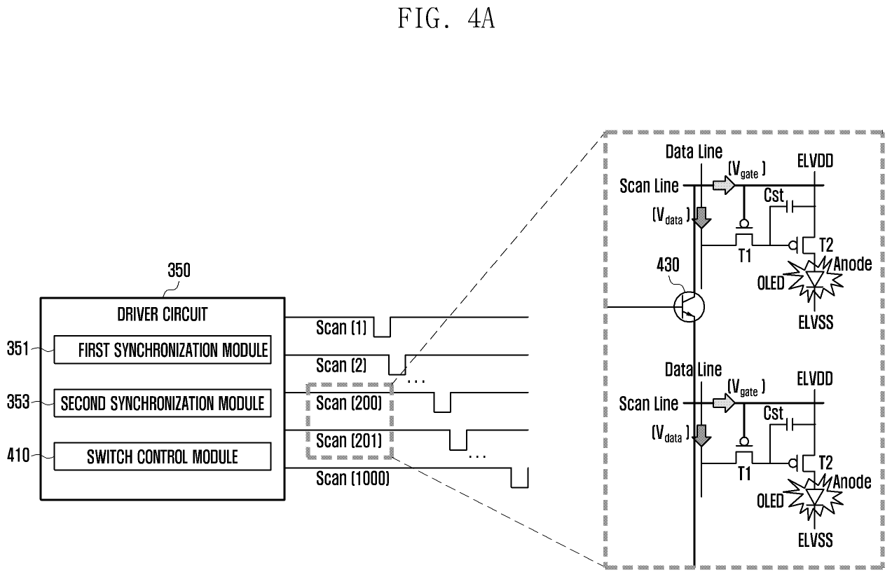

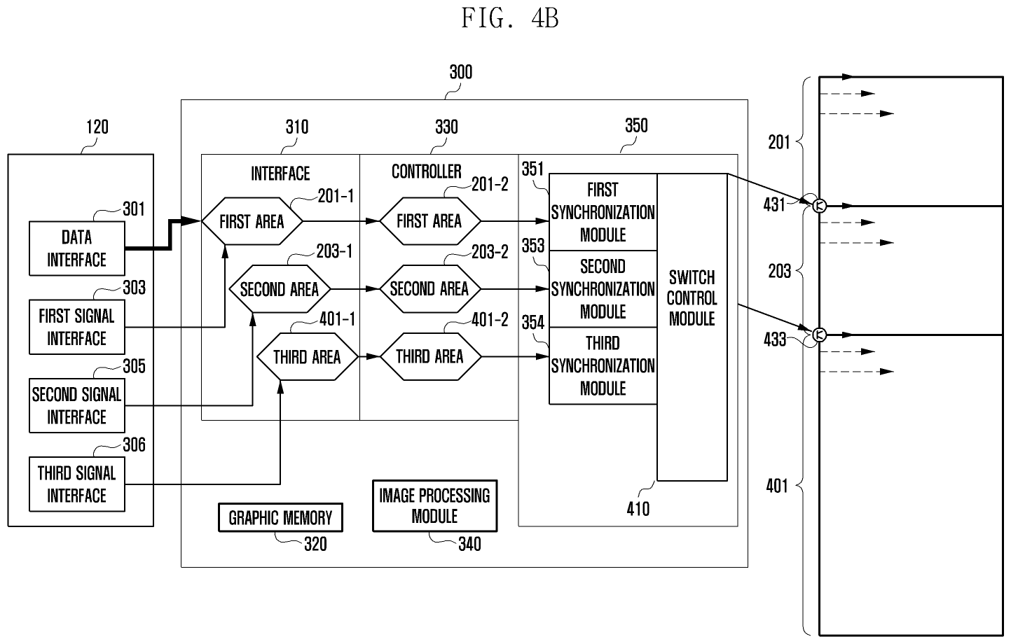

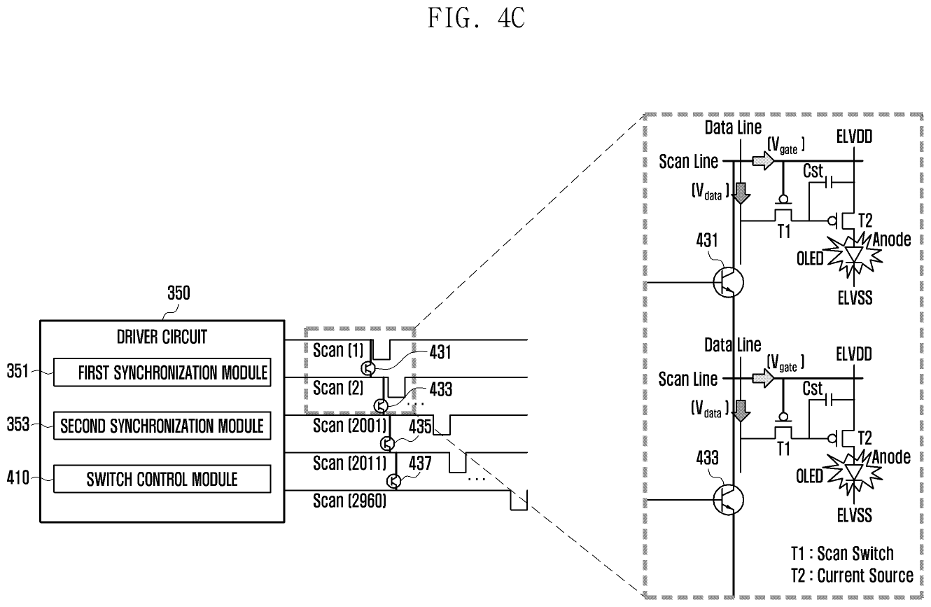

FIG. 4A to FIG. 4C are diagrams illustrating a configuration for controlling an area-specific refresh rate of a display of an electronic device according to certain embodiments.

FIG. 4A is a configuration diagram in which an electronic device according to certain embodiments includes a switch circuit.

Referring to FIG. 4A, an electronic device (e.g., the electronic device 101 in FIG. 1) according to certain embodiments may include a processor 120, a display driver integrated circuit 300, and a display panel 370. As illustrated in FIG. 3A, the processor 120 may include a data interface 301, a first signal interface 303, and a second signal interface 305. Alternatively, as illustrated in FIG. 3C, the processor 120 may include a first data interface 307, a first signal interface 303, a second data interface 309, and a second signal interface 305. A specific description for the processor 120, the display driver integrated circuit 300, and the display panel 370 has been sufficiently given with reference to FIG. 3A, and thus a detailed description may be omitted.

The display driver integrated circuit 300 may include an interface 310, a graphic memory 320, a controller 330, an image processing module 340, or a driver circuit 350. The driver circuit 350 may include a first synchronization module 351, a second synchronization module 353, and a switch control module 410. Although not illustrated, the driver circuit 350 may include the gate driver 355 and the source driver 357 illustrated in FIG. 3B. For example, the gate driver 355 may include the switch control module 410. As another example, the switch control module 410 may include the gate driver 355.

The first synchronization module 351 may synchronize a first scan signal and a first data signal for operating the first area 201 of the display panel 370, according to a first refresh rate configured by the processor 120. The second synchronization module 353 may synchronize a second scan signal and a second data signal for operating the second area 203 of the display panel 370, according to a second refresh rate configured by the processor 120. The second synchronization module 353 may change the signals synchronized by the first synchronization module 351, to synchronize a second scan signal and a second data signal according to the second refresh rate. The gate driver (e.g., the gate driver 355 in FIG. 3B) may scan and operate scan lines connected to the pixels of the display panel 370. The gate driver 355 may transmit a scan signal through the scan lines. The source driver (e.g., the source driver 357 in FIG. 3B) may operate data lines connected to the pixels of the display panel 370.

The electronic device 101 may include a switch circuit 430 between the first area 201 and the second area 203 to turn on or off the switch circuit 430 to operate the first area 201 or the second area 203 of the display panel 370 at the same or different refresh rates. The processor 120 may transfer a control signal for turning on or off the switch circuit 430 to the display driver integrated circuit 300 through the first signal interface 303 or the second signal interface 305.

The switch circuit 430 may be disposed at a part between scan lines, which is the boundary point between the first area 201 and the second area 203 of the display panel 370. For example, if the first area 201 includes scan lines 1-200, and the second area 203 includes scan lines 201-1000, the switch circuit 430 may be disposed between the scan line 200 and the scan line 201. The numbers following the scan lines merely correspond to an example for helping understanding of the disclosure, and do not limit the disclosure.

The controller 330 may control the switch control module 410 included in the driver circuit 350 according to a control of the processor 120. The switch control module 410 may control the switch circuit 430 according to a control of the controller 330. For example, in a case where the first area 201 and the second area 203 of the display panel 370 are operated at the same refresh rate, the switch control module 410 may transmit a control signal for turning on the switch circuit 430 to the display panel 370. In a case where the first area 201 and the second area 203 of the display panel 370 are operated at the different refresh rates, the switch control module 410 may transmit a control signal for turning off the switch circuit 430 to the display panel 370.

FIG. 4B is a configuration diagram in which an electronic device according to certain embodiments includes multiple switch circuits.

Referring to FIG. 4B, an electronic device (e.g., the electronic device 101 in FIG. 1) according to certain embodiments may include a processor 120, a display driver integrated circuit 300, and a display panel 370. The processor 120 may include a data interface 301, a first signal interface 303, a second signal interface 305, and a third signal interface 306. The diagram is a configuration diagram of the processor 120 illustrated in FIG. 2. However, as illustrated in FIG. 3C, the processor 120 may include a first data interface 307, a first signal interface 303, a second data interface 309, a second signal interface 305, a third data interface, and a third signal interface 306.

The data interface 301 may transmit image data of a user interface to be displayed on the display panel 370 to the display driver integrated circuit 300. The first signal interface 303 may transmit a first signal to the display driver integrated circuit 300 correspondingly to the first area 201 of the display panel 370. The first signal is a frequency change signal, and may include a first refresh rate corresponding to the first area 201. The second signal interface 305 may transmit a second signal to the display driver integrated circuit 300 correspondingly to the second area 203 of the display panel 370. The second signal may include a second refresh rate corresponding to the second area 203. The third signal interface 306 may transmit a third signal to the display driver integrated circuit 300 correspondingly to a third area 401 of the display panel 370. The third signal may include a third refresh rate corresponding to the third area 401.

The processor 120 may generate a user interface to be displayed on the display panel 370, and determine a refresh rate, based on the generated user interface. The user interface may include text so as to correspond to the first area 201, include a video so as to correspond to the second area 203, and include an image so as to correspond to the third area 401. Based on the user interface, the electronic device 101 may configure a first refresh rate (e.g., 30 Hz) so as to correspond to the first area 201, configure a second refresh rate (e.g., 60 Hz) so as to correspond to the second area 203, and configure a third refresh rate (e.g., 30 Hz) so as to correspond to the third area 401. The processor 120 may include the configured first refresh rate in the first signal and transmit the signal to the display driver integrated circuit 300, may include the configured second refresh rate in the second signal and transmit the signal to the display driver integrated circuit 300, and may include the configured third refresh rate in the third signal and transmit the signal to the display driver integrated circuit 300. The first refresh rate to the third refresh rate may be the same or different from each other.

The display driver integrated circuit 300 may include an interface 310, a graphic memory 320, a controller 330, an image processing module 340, or a driver circuit 350. The controller 330 may control an operation of the display driver integrated circuit 300. According to an embodiment, the controller 330 may: transfer, to the driver circuit 350, a first control signal allowing an operation having a first refresh rate correspondingly to a first area 201-2; transfer, to the driver circuit 350, a second control signal allowing an operation having a second refresh rate correspondingly to a second area 203-2; and transfer, to the driver circuit 350, a third control signal allowing an operation having a third refresh rate correspondingly to a third area 401-2.

The driver circuit 350 may be operated according to a control of the controller 330. The driver circuit 350 may include a first synchronization module 351, a second synchronization module 353, a third synchronization module 354, and a switch control module 410. Although not illustrated, the driver circuit 350 may include the gate driver 355 and the source driver 357 illustrated in FIG. 3B.

The first synchronization module 351 may synchronize a first scan signal and a first data signal for operating the first area 201 of the display panel 370, according to a first refresh rate configured by the processor 120. The second synchronization module 353 may synchronize a second scan signal and a second data signal for operating the second area 203 of the display panel 370, according to a second refresh rate configured by the processor 120. The second synchronization module 353 may change the signals synchronized by the first synchronization module 351, to synchronize a second scan signal and a second data signal according to the second refresh rate. The third synchronization module 354 may synchronize a third scan signal and a third data signal for operating the third area 401 of the display panel 370, according to a third refresh rate configured by the processor 120. The third synchronization module 354 may change the signals synchronized by the first synchronization module 351, to synchronize a third scan signal and a third data signal according to the third refresh rate.

The display panel 370 may include a first switch circuit 431 disposed between the first area 201 and the second area 203, and a second switch circuit 433 disposed between the second area 203 and the third area 401. The processor 120 may turn on or off the first switch circuit 431 or the second switch circuit 433 to operate the first area 201, the second area 203, or the third area 401 of the display panel 370 at the same or different refresh rates. The gate driver 355 may scan and operate scan lines connected to pixels of the display panel 370. The gate driver 355 may transmit a scan signal through the scan lines. The source driver 357 may operate data lines connected to pixels of the display panel 370.

The first switch circuit 431 may be disposed at a part between scan lines, which is the boundary point between the first area 201 and the second area 203. For example, if the first area 201 includes scan lines 1-200, the second area 203 includes scan lines 201-500, and the third area 401 includes scan lines 501-1000, the first switch circuit 431 may be disposed between the scan line 200 and the scan line 201, and the second switch circuit 433 may be disposed between the scan line 500 and the scan line 501.

The controller 330 may control the switch control module 410 included in the driver circuit 350 according to a control of the processor 120. The switch control module 410 may control the first switch circuit 431 or the second switch circuit 433 according to a control of the controller 330. For example, in a case where the first area 201 to the third area 401 of the display panel 370 are operated at the same refresh rate, the switch control module 410 may transmit a control signal for turning on the first switch circuit 431 and the second switch circuit 433 to the display panel 370. In a case where the first area 201 and the second area 203 are operated at the same refresh rate, and the second area 203 and the third area 401 are operated at the different refresh rates, the switch control module 410 may transmit a control signal for turning on the first switch circuit 431 and turning off the second switch circuit 433 to the display panel 370. In a case where the first area 201 and the second area 203 are operated at the different refresh rates, and the second area 203 and the third area 401 are operated at the same refresh rate, the switch control module 410 may transmit a control signal for turning off the first switch circuit 431 and turning on the second switch circuit 433 to the display panel 370. In a case where the first area 201 to the third area 401 are operated at the different refresh rates, the switch control module 410 may transmit a control signal for turning off the first switch circuit 431 and the second switch circuit 433 to the display panel 370.

FIG. 4C is a configuration diagram of a driver circuit and a display panel according to certain embodiments.

Referring to FIG. 4C, the driver circuit 350 may include multiple synchronization modules (e.g., a first synchronization module 351 and a second synchronization module 353) and/or a switch control module 410. The display panel 370 may include a switch circuit between two scan lines. For example, the display panel 370 may include: a first switch circuit 431 between a first scan line (scan 1) and a second scan line (scan 2); a second switch circuit 433 between the second scan line (scan 2) and a third scan line (scan 3); a 2001-th switch circuit 435 between a 2001-th scan line (scan 2001) and a 2002-th scan line; and a n-th switch circuit 437 between a 2011-th scan line (scan 2011) and a 2012-th scan line. If there are 2960 scan lines in the display panel 370, a total of 2959 switch circuits may be included because a switch circuit is disposed between two scan lines.

The processor 120 may turn on or off multiple switch circuits (e.g., the first switch circuit 431 to the n-th switch circuit 437) to operate each scan line of the display panel 370 at the same or different refresh rates. The processor 120 may configure different refresh rates for areas desired by a user in the entire area of the display panel 370 rather than configure refresh rates so as to correspond to designated areas, such as the first area 201 and the second area 203 of the display panel 370.

The processor 120 may generate a user interface to be displayed on the display panel 370, and determine a refresh rate, based on the generated user interface. The processor 120 may determine a refresh rate, based on the size of the display panel 370 and a user interface. For example, the user interface may include text from the first scan line to the 200-th scan line (e.g., a first area), include a video from the 201-th scan line to the 500-th scan line (e.g., a second area), include an image from the 501-th scan line to the 1500-th scan line (e.g., a third area), and include a video from the 1501-th scan line to the 2960-th scan line (e.g., a fourth area). Based on the user interface, the processor 120 may configure a first refresh rate so as to correspond to the first area, configure a second refresh rate so as to correspond to the second area, configure a third refresh rate so as to correspond to the third area, and configure a fourth refresh rate so as to correspond to the fourth area.

The processor 120 may include the configured first refresh rate in a first signal and transmit the signal to the display driver integrated circuit 300, may include the configured second refresh rate in a second signal and transmit the signal to the display driver integrated circuit 300, may include the configured third refresh rate in a third signal and transmit the signal to the display driver integrated circuit 300, and may include the configured fourth refresh rate in a fourth signal and transmit the signal to the display driver integrated circuit 300. The first refresh rate to the fourth refresh rate may be the same or different from each other. According to certain embodiments, the processor 120 may be connected to an interface which transmits each signal to the display driver integrated circuit 300.

According to certain embodiments, the driver circuit 350 may include a synchronization module so as to correspond to a switch circuit. For example, if the display panel 370 includes 2959 switch circuits, the driver circuit 350 may include 2960 synchronization modules. The number of synchronization modules may be larger than that of switch circuits to operate display areas separated by switch circuits. For example, the number of synchronization modules may be one more than that of switch circuits. Alternatively, the driver circuit 350 may include more than two synchronization modules to synchronize a scan signal of a gate driver and a data signal of a source driver. The first synchronization module 351 may synchronize a first scan signal and a first data signal for operating a first area of the display panel 370, according to a first refresh rate configured by the processor 120. The second synchronization module 353 may synchronize a second scan signal and a second data signal for operating a second area of the display panel 370, according to a second refresh rate configured by the processor 120. The second synchronization module 353 may change the signals synchronized by the first synchronization module 351, to synchronize a second scan signal and a second data signal according to the second refresh rate. The second synchronization module 353 or a third synchronization module (not illustrated) may synchronize a third scan signal and a third data signal for operating a third area of the display panel 370, according to a third refresh rate configured by the processor 120. The third synchronization module (not illustrated) or a fourth synchronization module (not illustrated) may synchronize a fourth scan signal and a fourth data signal for operating a fourth area of the display panel 370, according to a fourth refresh rate configured by the processor 120.

The controller 330 may control the switch control module 410 included in the driver circuit 350 according to a control of the processor 120. The switch control module 410 may control multiple switch circuits (e.g., the first switch circuit 431 to the n-th switch circuit 437) according to a control of the controller 330. For example, in a case where the entire area of the display panel 370 is operated at the same refresh rate, the switch control module 410 may transmit a control signal for turning on multiple switch circuits (e.g., the first switch circuit 431 to the n-th switch circuit 437) to the display panel 370. In a case where the first area to the fourth area are operated at different refresh rates, the switch control module 410 may transmit, to the display panel 370, a control signal for turning off: the 200-th switch circuit disposed between the first area (e.g., from the first scan line to the 200-th scan line) and the second area (e.g., the 201-th scan line to the 500-th scan line); the 1499-th switch circuit disposed between the second area and the third area (e.g., the 501-th scan line to the 1500-th scan line); and the 1500-th switch circuit disposed between the third area and the fourth area (e.g., the 1501-th scan line to the 2960-th scan line).

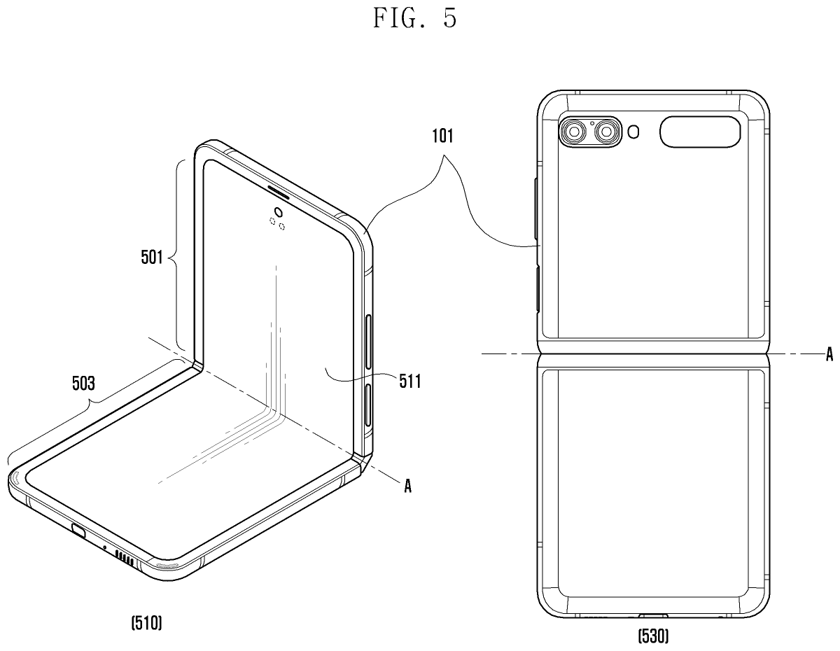

FIG. 5 is a diagram illustrating a configuration for controlling an area-specific refresh rate of a display of a first type flexible electronic device according to certain embodiments.

The flexible electronic device can bend along line A. As a result, display area 501 will have different angle with respect to the ground as will display area 503. In certain embodiments, display area 501 can receive a first scan signal with a first refresh rate, and display area 503 can receive a second scan signal with a second refresh rate.

FIG. 5 illustrates a front plan view 510 and a rear plan view 530 of a first type flexible electronic device (e.g., the electronic device 101 in FIG. 1). The front plan view 510 may show surfaces including a flexible display 511 (e.g., the display module 160 in FIG. 1), and the rear plan view 530 may show surfaces not including the display module 160. The display module 160 may be disposed to extend from a first area 501 to a second area 503. The surfaces of the electronic device 101, which include the display module 160, may be oppositely folded on each other around a folding axis (axis A).

The electronic device 101 may include a pair of housings which are rotatably coupled to each other so that the housings are oppositely folded on each other around a folding axis (e.g., axis A). The pair of housings may include a first housing corresponding to the first area 501, and a second housing corresponding to the second area 503. The electronic device 101 may include a hinge module (not illustrated), based on the folding axis, and the first area 501 and the second area 503 may be oppositely folded on each other by the hinge module. The first housing and the second housing may be arranged at both sides of the folding axis, and may be substantially symmetric with respect to the folding axis.

The angle or distance between the first housing and the second housing may vary according to whether the electronic device 101 is in an unfolded state (a flat state), a folded state, or an intermediate state. The electronic device may be operated such that the surfaces including the flexible display are oriented in the same direction in the unfolded state, and the surfaces including the flexible display are oriented in the opposite directions in the folded state.

FIG. 5 illustrates an intermediate state, and the intermediate state may indicate that different surfaces (e.g., the first area 501 and the second area 503) including the flexible display make a predetermined angle. As illustrated in FIG. 5, in an intermediate state in which the first area 501 and the second area 503 make a predetermined angle, the electronic device 101 may operate the first area 501 and the second area 503 at the same or different refresh rates. In the electronic device 101, a display may be divided into the first area 201 and the second area 203. The electronic device 101 may identically or differently determine refresh rates of the first area 501 and the second area 503, based on a user interface displayed on the first area 501 and the second area 503. Alternatively, even when the electronic device 101 is in the unfolded state, the electronic device 101 may operate the first area 501 and the second area 503 at the same or different refresh rates.

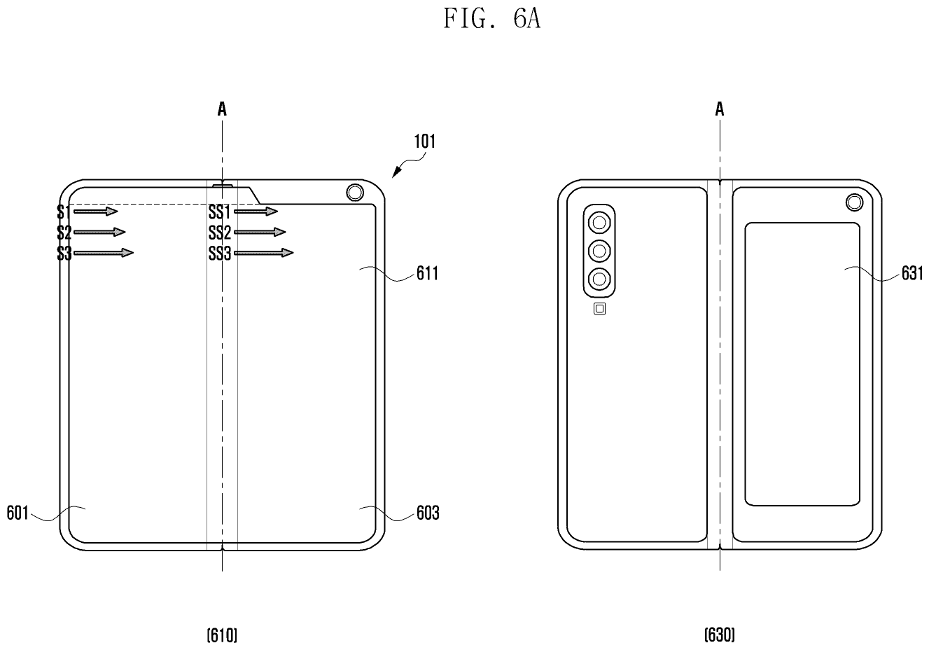

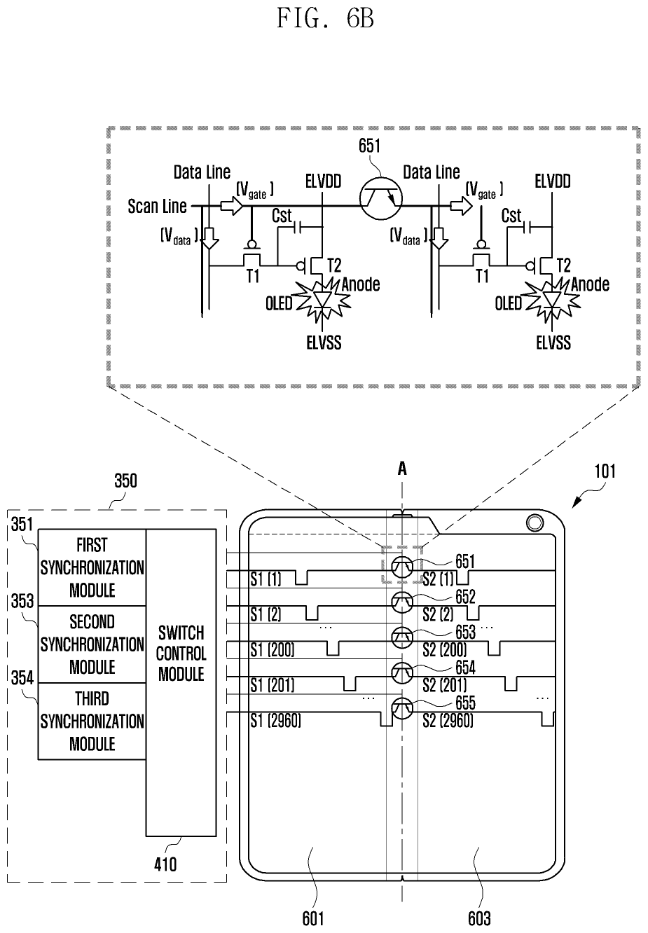

FIG. 6A and FIG. 6B are diagrams illustrating a configuration for controlling an area-specific refresh rate of a display of a second type flexible electronic device according to certain embodiments.

FIG. 6A illustrates a front plan view and a rear plan view of a second type flexible electronic device. The flexible electronic device can bend along line A. As a result, display area 601 will have different angle with respect to the ground as will display area 603. In certain embodiments, display area 601 can receive a first scan signal with a first refresh rate, and display area 603 can receive a second scan signal with a second refresh rate.

Referring to FIG. 6A, the front plan view 610 may show surfaces including a flexible display 611 (e.g., the display module 160 in FIG. 1), and the rear plan view 630 may show surfaces not including the display module 160. Alternatively, the front plan view 610 may show surfaces in which a first display module 611 (e.g., a main display) is included in the entire area (e.g., a first area 601 and a second area 603) corresponding to a front surface, and the rear plan view 630 may show surfaces in which a second display module 631 (e.g., a sub display) is included in a partial area of a rear surface. The display module 611 may be disposed to extend from the first area 601 to the second area 603. The surfaces of the electronic device 101, which include the display module 611, may be oppositely folded on each other around a folding axis (axis A).

The electronic device 101 may include a pair of housings which are rotatably coupled to each other so that the housings are oppositely folded on each other around a folding axis (e.g., axis A). The pair of housings may include a first housing corresponding to the first area 601, and a second housing corresponding to the second area 603. The electronic device 101 may include a hinge module (not illustrated), based on the folding axis, and the first area 601 and the second area 603 may be oppositely folded on each other by the hinge module. The first housing and the second housing may be arranged at both sides of the folding axis, and may be substantially symmetric with respect to the folding axis.

The angle or distance between the first housing and the second housing may vary according to whether the electronic device 101 is in an unfolded state, a folded state, or an intermediate state. The electronic device may be operated such that the surfaces including the flexible display are oriented in the same direction in the unfolded state, and the surfaces including the flexible display are oriented in the opposite directions in the folded state.

FIG. 6B illustrates an example of controlling an area-specific refresh rate of of a display of a second type flexible electronic device.

Referring to FIG. 6B, a second type flexible electronic device 101 may include a first display module 611 (e.g., the display module 160 in FIG. 1) in a front surface (e.g., a first area 601 and a second area 603) of the electronic device 101. The first display module 611 may include a display driver integrated circuit (e.g., the display driver integrated circuit 300 in FIG. 4C) and a display panel (e.g., the display panel 370 in FIG. 4C). The display driver integrated circuit 300 may include an interface 310, a graphic memory 320, a controller 330, an image processing module 340, and/or a driver circuit 350.

The display panel 370 may include at least one switch circuit (e.g., a first switch circuit 651) between scan lines extending to the first area 601 and the second area 603 around a folding axis (e.g., axis A). The at least one switch circuit may be disposed in the horizontal direction to separate the first area 601 and the second area 603. The display driver integrated circuit 300 may operate the first area 601 and the second area 603 of the display panel 370 separately. The display driver integrated circuit 300 may transfer, to the display panel 370, a first scan signal (e.g., signals S1(1), S1(2), . . . , S1(200)) for operating the first area 601 of the display panel 370, and a second scan signal (e.g., signals S2(1), S2(2), . . . , S2(200)) for operating the second area 603 of the display panel 370.

The driver circuit 350 may be operated according to a control of the controller 330. The driver circuit 350 may include a first synchronization module 351, a second synchronization module 353, a third synchronization module 354, and a switch control module 410. Although not illustrated, the driver circuit 350 may include the gate driver 355 and the source driver 357 illustrated in FIG. 3B.

The first synchronization module 351 may synchronize a first scan signal and a first data signal for operating the first area 601 of the display panel 370, according to a first refresh rate configured by the processor 120. The second synchronization module 353 may synchronize a second scan signal and a second data signal for operating the second area 603 of the display panel 370, according to a second refresh rate configured by the processor 120. The second synchronization module 353 may change the signals synchronized by the first synchronization module 351, to synchronize a second scan signal and a second data signal according to the second refresh rate.

According to certain embodiments, the driver circuit 350 may include a synchronization module so as to correspond to the switch circuit 651. For example, the driver circuit 350 may include more than three synchronization modules to synchronize a scan signal of a gate driver and a data signal of a source driver. The third synchronization module 354 may synchronize a third scan signal and a third data signal for operating a third area of the display panel 370, according to a third refresh rate configured by the processor 120. The third area may include at least one of a part of the first area 601, a part of the second area 603, or a part of the first area 601 and the second area 603.

The switch control module 410 may control at least one switch circuit (e.g., the first switch circuit 651) according to a control of the controller 330. For example, in a case where the entire area of the display panel 370 is operated at the same refresh rate, the switch control module 410 may transmit a control signal for turning on the at least one switch circuit to the display panel 370. In a case where the first area 601 and the second area 603 are operated at the different refresh rates, the switch control module 410 may transmit a control signal for turning off the at least one switch circuit to the display panel 370. Alternatively, in a case where the first area 601, the second area 603, or the third area is operated at the different refresh rates, the switch control module 410 may transmit, to the display panel 370, a control signal for turning on some switch circuits among multiple switch circuits and turning off some switch circuits.

An electronic device (e.g., the electronic device 101 in FIG. 1) according to certain embodiments may include: a display (e.g., the display module 160 in FIG. 1); a memory (e.g., the memory 130 in FIG. 1); and a processor (e.g., the processor 120 in FIG. 1) operatively connected to the display and the memory, wherein the processor is configured to: based on a user interface displayed on the display, generate a first signal configured to have a first refresh rate corresponding to a first area of the display, and a second signal configured to have a second refresh rate corresponding to a second area of the display; and transfer a first signal based on the first refresh rate and a second signal based on the second refresh rate to the display; and wherein the first signal causes the first area to be refreshed at the first refresh rate, the second signal causes the second area to be refreshed at the second refresh rate.

The display may include: a display driver integrated circuit (e.g., the display driver integrated circuit 300 in FIG. 3A and FIG. 3C); and a display panel (e.g., the display panel 370 in FIG. 3A and FIG. 3C), wherein the display driver integrated circuit is configured to operate the display panel, based on the first signal and the second signal.

The processor may be configured to transfer the first signal to the display driver integrated circuit through a first interface, and transfer the second signal through a second interface.

The display driver integrated circuit may be configured to, if the first refresh rate and the second refresh rate are different from each other, synchronize a signal transmitted to the first area of the display panel according to the first refresh rate and synchronize a signal transmitted to the second area of the display panel according to the second refresh rate.

The display driver integrated circuit may be configured to, if the first refresh rate and the second refresh rate are different from each other, synchronize a first scan signal and a first data signal for operating the first area of the display panel according to the first refresh rate, and synchronize a second scan signal and a second data signal for operating the second area of the display panel according to the second refresh rate.

The display driver integrated circuit may be configured to, if the first refresh rate and the second refresh rate are different from each other, synchronize a first scan signal and a first data signal for operating the first area of the display panel according to the first refresh rate, and change the synchronized signals to synchronize a second scan signal and a second data signal for operating the second area of the display panel according to the second refresh rate.

The electronic device may further include at least one switch circuit (e.g., the switch circuit 430 in FIG. 4A) between the first area and the second area, and the processor may be configured to control the at least one switch circuit, based on the first refresh rate and the second refresh rate.

The processor may be configured to: if the first refresh rate and the second refresh rate are identical to each other, turn on the at least one switch circuit; and if the first refresh rate and the second refresh rate are different from each other, turn off the at least one switch circuit.

The at least one switch circuit may be configured to be disposed in a scan line between the first area and the second area for operation of the display.

A display device (e.g., the display module 160 in FIG. 1) according to certain embodiments may include: a display panel (e.g., the display panel 370 in FIG. 3A and FIG. 3C); and a display driver integrated circuit (e.g., the display driver integrated circuit 300 in FIG. 3A and FIG. 3C) including a driver circuit (e.g., the driver circuit 350 in FIG. 3A and FIG. 3C) electrically connected to the display panel, wherein the driver circuit includes: a driver (e.g., the gate driver 355 or the source driver 357 in FIG. 3B) electrically connected to the display panel; a first synchronization module (e.g., the first synchronization module 351 in FIG. 3A to FIG. 3C) configured to synchronize a signal transmitted to the driver circuit according to a first refresh rate corresponding to a first area (e.g., the first area 201 in FIG. 3A to FIG. 3C) of the display panel; and a second synchronization module (e.g., the second synchronization module 353 in FIG. 3A to FIG. 3C) configured to synchronize a signal transmitted to the driver circuit according to a second refresh rate corresponding to a second area (e.g., the second area 203 in FIG. 3A to FIG. 3C) of the display panel.

The driver may include: a gate driver configured to operate a scan line connected to multiple pixels included in the display panel, transmit a first scan signal so as to correspond to the first area of the display panel, and transmit a second scan signal so as to correspond to the second area of the display panel; and a source driver configured to operate a data line connected to the pixels of the display panel, transmit a first data signal so as to correspond to the first area of the display panel, and transmit a second data signal so as to correspond to the second area of the display panel.

The first synchronization module may be configured to synchronize the first scan signal and the first data signal for operating the first area of the display panel according to the first refresh rate, and the second synchronization module may be configured to synchronize the second scan signal and the second data signal for operating the second area of the display panel according to the second refresh rate.

The first synchronization module may be configured to synchronize the first scan signal and the first data signal for operating the first area of the display panel according to the first refresh rate, and the second synchronization module may be configured to change the signals synchronized by the first synchronization module, to synchronize the second scan signal and the second data signal.

The display panel may further include at least one switch circuit (e.g., the switch circuit 430 in FIG. 4A) between the first area and the second area, and the display driver integrated circuit may be configured to control the at least one switch circuit, based on the first refresh rate and the second refresh rate.

The display driver integrated circuit may be configured to: if the first refresh rate and the second refresh rate are identical to each other, turn on the at least one switch circuit; and if the first refresh rate and the second refresh rate are different from each other, turn off the at least one switch circuit.

The at least one switch circuit may be configured to be disposed in a scan line between the first area and the second area for operation of the display panel.

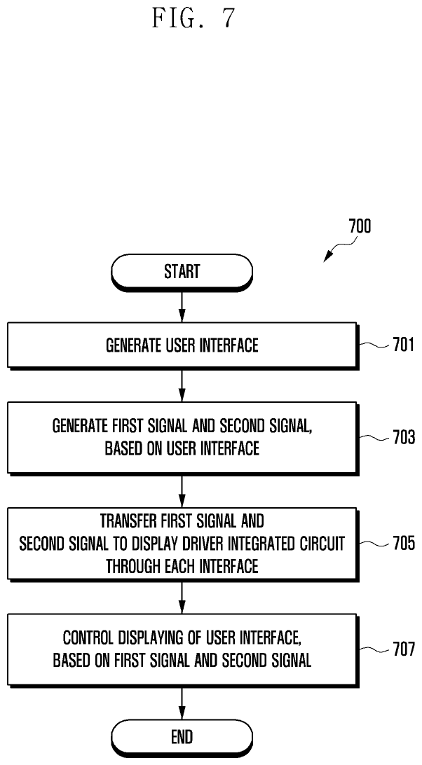

FIG. 7 is a flowchart 700 illustrating an operation method of an electronic device according to certain embodiments.

Referring to FIG. 7, in an operation 701, a processor (e.g., the processor 120 in FIG. 1) of an electronic device (e.g., the electronic device 101 in FIG. 1) according to certain embodiments may generate a user interface. The user interface may be displayed on a display (e.g., the display module 160 in FIG. 1) of the electronic device 101. The user interface may include at least one of a home screen of the electronic device 101 or an execution screen of an application. The processor 120 may generate a user interface, based on a user input.

In an operation 703, the processor 120 may generate a first signal and a second signal, based on the user interface. The first signal may include a first refresh rate corresponding to a first area (e.g., the first area 201 in FIG. 2 or the first area 501 in FIG. 5) of the display module 160. The second signal may include a second refresh rate corresponding to a second area (e.g., the second area 203 in FIG. 2 or the second area 503 in FIG. 5) of the display module 160. Based on the user interface, the processor 120 may operate the entire area of the display module 160 at the same refresh rate, or operate the first area 201 and the second area 203 of the display module 160 at different refresh rates. For example, the user interface may include text or an image so as to correspond to the first area 201, and include a video so as to correspond to the second area 203. The processor 120 may configure a first refresh rate so as to correspond to the first area 201, and configure a second refresh rate so as to correspond to the second area 203. The first refresh rate and the second refresh rate may be the same or different from each other.

According to certain embodiments, the processor 120 may sense a time point of generation of the user interface, the detection of a user input, or a change in the frame rate of a video included in the first area 201 or the second area 203 after the generation of the user interface, so as to determine whether to configure a first refresh rate or a second refresh rate.

In an operation 705, the processor 120 may transfer the first signal and the second signal to a display driver integrated circuit (e.g., the display driver integrated circuit 300 in FIG. 3A) through each interface. The display module 160 may include the display driver integrated circuit 300 and a display panel (e.g., the display panel 370 in FIG. 3A). The display driver integrated circuit 300 may operate the display panel 370 according to a control of the processor 120. The processor 120 may include a data interface for transmitting data corresponding to the user interface and a signal interface for transmitting a signal related to a refresh rate. If the data interface is a MIPI interface, the processor 120 may have one data interface (e.g., the data interface 301 in FIG. 3A) connected to the display driver integrated circuit 300. Alternatively, if the data interface is an RGB interface, the processor 120 may have a first data interface (e.g., the first data interface 307 in FIG. 3C) corresponding to the first area 201 and a second data interface (e.g., the second data interface 309 in FIG. 3C) corresponding to the second area 203, the first and second data interfaces being connected to the display driver integrated circuit 300.

Alternatively, the processor 120 may have a first signal interface (e.g., the first signal interface 303 in FIG. 3A or FIG. 3C) corresponding to the first area 201 and a second signal interface (e.g., the second signal interface 305 in FIG. 3A or FIG. 3C) corresponding to the second area 203, the first and second signal interfaces being connected to the display driver integrated circuit 300. The processor 120 may transfer the first signal to the display driver integrated circuit 300 through the first signal interface 303, and transfer the second signal to the display driver integrated circuit 300 through the second signal interface 305. The processor 120 may transmit data corresponding to the user interface to the display driver integrated circuit 300.

In an operation 707, the processor 120 may control displaying of the user interface, based on the first signal and the second signal. The display driver integrated circuit 300 may transfer, to a driver circuit (e.g., the driver circuit 350 in FIG. 3A or FIG. 3C), a first control signal allowing an operation having a first refresh rate correspondingly to the first area 201, and transfer, to the driver circuit 350, a second control signal allowing an operation having a second refresh rate correspondingly to the second area 203. The display driver integrated circuit 300 may include the driver circuit 350. The driver circuit 350 may include individual synchronization modules corresponding to different areas (e.g., the first area 201 and the second area 203) of the display panel 370 to operate the areas at different refresh rates. For example, the driver circuit 350 may include a first synchronization module (e.g., the first synchronization module 351 in FIG. 3A or FIG. 3C), a second synchronization module (e.g., the second synchronization module 353 in FIG. 3A or FIG. 3C), or a driver (not illustrated, refer to FIG. 3B).

The driver may include a gate driver or a source driver (or a data driver). The gate driver may scan and operate scan lines connected to pixels of the display panel 370. The gate driver may transmit a scan signal through the scan lines. The gate driver may transmit a first scan signal so as to correspond to the first area 201 of the display panel 370, and transmit a second scan signal so as to correspond to the second area 203 of the display panel 370. The source driver may operate data lines connected to pixels of the display panel 370. The source driver may transmit a first data signal so as to correspond to the first area 201 of the display panel 370, and transmit a second data signal so as to correspond to the second area 203 of the display panel 370.

The first synchronization module 351 may synchronize a first scan signal and a first data signal for operating the first area 201 of the display panel 370 according to a first refresh rate configured by the processor 120. The second synchronization module 353 may synchronize a second scan signal and a second data signal for operating the second area 203 of the display panel 370 according to a second refresh rate configured by the processor 120. The second synchronization module 353 may change the signals synchronized by the first synchronization module 351, to synchronize a second scan signal and a second data signal according to the second refresh rate.

An example of a case where the first area 201 and the second area 203 are separate has been described with reference to FIG. 7, but the same or similar operations may be applied to even a case where multiple areas are separate.

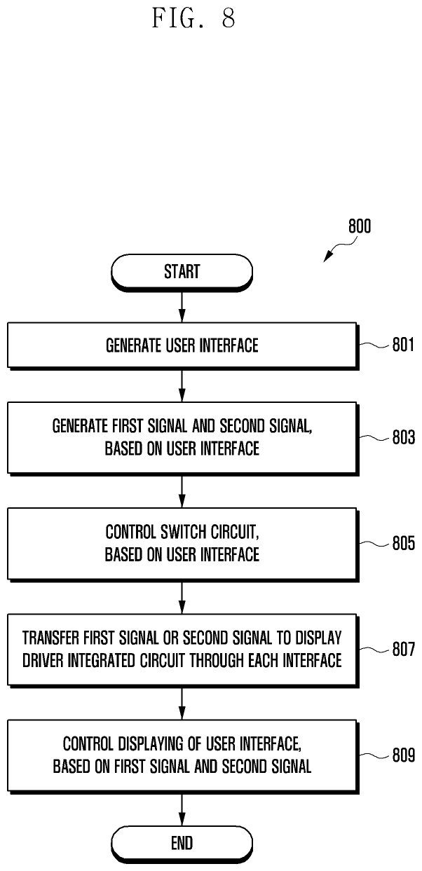

FIG. 8 is a flowchart 800 illustrating a method for controlling a refresh rate of an electronic device according to certain embodiments.

Referring to FIG. 8, in an operation 801, a processor (e.g., the processor 120 in FIG. 1) of an electronic device (e.g., the electronic device 101 in FIG. 1) according to certain embodiments may generate a user interface. The user interface may be displayed on a display (e.g., the display module 160 in FIG. 1) of the electronic device 101. The processor 120 may generate a user interface, based on a user input. The operation 801 is identical or similar to the operation 701 of FIG. 7 and thus a detailed description thereof may be omitted.

In an operation 803, the processor 120 may generate a first signal and a second signal, based on the user interface. The first signal may include a first refresh rate corresponding to a first area (e.g., the first area 201 in FIG. 2 or the first area 501 in FIG. 5) of the display module 160. The second signal may include a second refresh rate corresponding to a second area (e.g., the second area 203 in FIG. 2 or the second area 503 in FIG. 5) of the display module 160. For example, the processor 120 may configure a first refresh rate so as to correspond to the first area 201, and configure a second refresh rate so as to correspond to the second area 203. The first refresh rate and the second refresh rate may be the same or different from each other. The operation 803 is identical or similar to the operation 703 of FIG. 7 and thus a detailed description thereof may be omitted.

In an operation 805, the processor 120 may control a switch circuit (e.g., the switch circuit 430 in FIG. 4A), based on the user interface. The display module 160 may include the display driver integrated circuit 300 and a display panel (e.g., the display panel 370 in FIG. 3A). The switch circuit 430 may be disposed between the first area 201 and the second area 203 of the display panel 370. For example, if the first area 201 includes scan lines 1-500, and the second area 203 includes scan lines 501-2960, the switch circuit 430 may be disposed between the scan line 500 and the scan line 501. The numbers following the scan lines merely correspond to an example for helping understanding of the disclosure, and do not limit the disclosure. If the first refresh rate and the second refresh rate are the same, the processor 120 may transmit a control signal for turning on the switch circuit 430. If the first refresh rate and the second refresh rate are different from each other, the processor 120 may transmit a control signal for turning off the switch circuit 430. The processor 120 may transfer a control signal for turning on or off the switch circuit 430 to the display driver integrated circuit 300 through the first signal interface 303 or the second signal interface 305.

In an operation 807, the processor 120 may transfer the first signal and the second signal to a display driver integrated circuit (e.g., the display driver integrated circuit 300 in FIG. 3A) through each interface. The display driver integrated circuit 300 may operate the display panel 370 according to a control of the processor 120. The processor 120 may include a data interface for transmitting data corresponding to the user interface and a signal interface for transmitting a signal related to a refresh rate. The processor 120 may have a first signal interface (e.g., the first signal interface 303 in FIG. 3A or FIG. 3C) corresponding to the first area 201 and a second signal interface (e.g., the second signal interface 305 in FIG. 3A or FIG. 3C) corresponding to the second area 203, the first and second signal interfaces being connected to the display driver integrated circuit 300. The processor 120 may transfer the first signal to the display driver integrated circuit 300 through the first signal interface 303, and transfer the second signal to the display driver integrated circuit 300 through the second signal interface 305. The processor 120 may transmit data corresponding to the user interface to the display driver integrated circuit 300. The operation 807 is identical or similar to the operation 705 of FIG. 7 and thus a detailed description thereof may be omitted.

FIG. 8 illustrates that the operation 805 and the operation 807 are operated separately, but the operation 805 and the operation 807 may be operated simultaneously. Alternatively, FIG. 8 illustrates that the operation 805 is performed first, and then the operation 807 is performed, but the operation 807 may be performed first and then the operation 805 may be operated.

In an operation 809, the processor 120 may control displaying of the user interface, based on the first signal and the second signal. The display driver integrated circuit 300 may transfer, to a driver circuit (e.g., the driver circuit 350 in FIG. 3A or FIG. 3C), a first control signal allowing an operation having a first refresh rate correspondingly to the first area 201, and transfer, to the driver circuit 350, a second control signal allowing an operation having a second refresh rate correspondingly to the second area 203. If the first refresh rate and the second refresh rate are different from each other, the first area 201 and the second area 203 are separated by the switch circuit 430 so that the first area 201 may be operated at the first refresh rate, and the second area 203 may be operated at the second refresh rate. The operation 809 is identical or similar to the operation 707 of FIG. 7 and thus a detailed description thereof may be omitted.

An example of a case where the first area 201 and the second area 203 are separate has been described with reference to FIG. 8, but the same or similar operations may be applied to even a case where multiple areas (e.g., FIG. 4C or FIG. 6B) are separate.

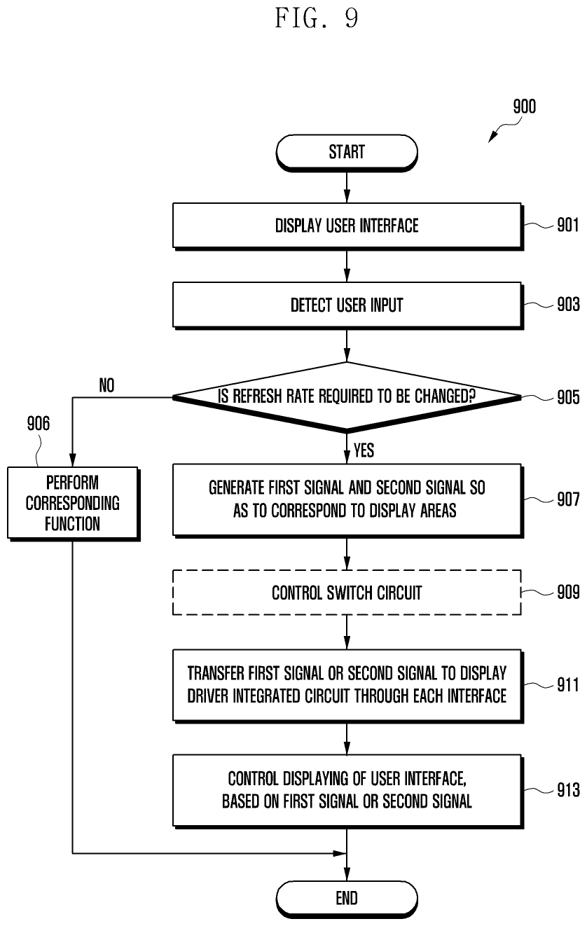

FIG. 9 is a flowchart 900 illustrating a method for controlling a display refresh rate of an electronic device according to certain embodiments.

Referring to FIG. 9, in an operation 901, a processor (e.g., the processor 120 in FIG. 1) of an electronic device (e.g., the electronic device 101 in FIG. 1) according to certain embodiments may display a user interface through a display (e.g., the display module 160 in FIG. 1). The operation 901 may imply the operation 707 of FIG. 7 or the operation 809 of FIG. 8. For example, the user interface may be an execution screen of an application.

In an operation 903, the processor 120 may detect a user input. The user input may be detected from the display module 160 or an input module (e.g., the input module 150 in FIG. 1). The user input may correspond to selecting a menu item, inputting text, or moving a content-displayed area in the execution screen of the application.

In an operation 905, the processor 120 may determine (or identify) whether a refresh rate is required to be changed due to the user input. For example, the user input may correspond to moving a video that is being displayed on a first area (e.g., the first area 201 in FIG. 2), to a second area (e.g., the second area 203 in FIG. 2). Alternatively, the user input may correspond to: changing the mode of the electronic device 101 into a horizontal mode while operating the electronic device 101 in a vertical mode and displaying a video on the first area 201; and changing the mode of the electronic device 101 into a vertical mode while operating the electronic device 101 in a horizontal mode and displaying a video on the entire area of the display module 160. If a user input as described above is detected, the processor 120 may determine that a refresh rate is required to be changed. Alternatively, if the user input corresponds to changing a first video that is being displayed on the first area 201, into a second video, the processor 120 may determine that a refresh rate is not required to be changed. If a refresh rate is required to be changed, the processor 120 may perform an operation 907, and if a refresh rate is not required to be changed, the processor may perform an operation 906. As another example, the processor 120 may sense a time point of generation of the user interface, or a change in the frame rate of a video included in the first area 201 or the second area 203 after the generation of the user interface, so as to determine whether to configure a first refresh rate or a second refresh rate.

If a refresh rate is not required to be changed, the processor 120 may perform a corresponding function in the operation 906. The processor 120 may perform a function, based on a user input.

If a refresh rate is required to be changed, the processor 120 may generate a first signal and a second signal so as to correspond to display areas in the operation 907. The first signal may include a first refresh rate corresponding to a first area (e.g., the first area 201 in FIG. 2 or the first area 501 in FIG. 5) of the display module 160. The second signal may include a second refresh rate corresponding to a second area (e.g., the second area 203 in FIG. 2 or the second area 503 in FIG. 5) of the display module 160. Based on the user input, the processor 120 may configure a first refresh rate so as to correspond to the first area 201, and configure a second refresh rate so as to correspond to the second area 203. The first refresh rate and the second refresh rate may be the same or different from each other. The operation 907 is identical or similar to the operation 703 of FIG. 7 and thus a detailed description thereof may be omitted.

In an operation 909, the processor 120 may control a switch circuit (e.g., the switch circuit 430 in FIG. 4A). The display module 160 may include the display driver integrated circuit 300 and a display panel (e.g., the display panel 370 in FIG. 3A). The switch circuit 430 may be disposed between the first area 201 and the second area 203 of the display panel 370. If the first refresh rate and the second refresh rate are the same, the processor 120 may transmit a control signal for turning on the switch circuit 430. If the first refresh rate and the second refresh rate are different from each other, the processor 120 may transmit a control signal for turning off the switch circuit 430. The processor 120 may transfer a control signal for turning on or off the switch circuit 430 to the display driver integrated circuit 300 through the first signal interface 303 or the second signal interface 305. If the display panel 370 does not include the switch circuit 430, the operation 909 can be omitted.

In an operation 911, the processor 120 may transfer the first signal and the second signal to a display driver integrated circuit (e.g., the display driver integrated circuit 300 in FIG. 3A) through each interface. The display driver integrated circuit 300 may operate the display panel 370 according to a control of the processor 120. The processor 120 may include a data interface for transmitting data corresponding to the user interface and a signal interface for transmitting a signal related to a refresh rate. The processor 120 may have a first signal interface (e.g., the first signal interface 303 in FIG. 3A or FIG. 3C) corresponding to the first area 201 and a second signal interface (e.g., the second signal interface 305 in FIG. 3A or FIG. 3C) corresponding to the second area 203, the first and second signal interfaces being connected to the display driver integrated circuit 300. The processor 120 may transfer the first signal to the display driver integrated circuit 300 through the first signal interface 303, and transfer the second signal to the display driver integrated circuit 300 through the second signal interface 305. The processor 120 may transmit data corresponding to the user interface to the display driver integrated circuit 300. The operation 911 is identical or similar to the operation 705 of FIG. 7 and thus a detailed description thereof may be omitted.

In an operation 913, the processor 120 may control displaying of the user interface, based on the first signal and the second signal. The display driver integrated circuit 300 may transfer, to a driver circuit (e.g., the driver circuit 350 in FIG. 3A or FIG. 3C), a first control signal allowing an operation having a first refresh rate correspondingly to the first area 201, and transfer, to the driver circuit 350, a second control signal allowing an operation having a second refresh rate correspondingly to the second area 203. If the first refresh rate and the second refresh rate are different from each other, the first area 201 and the second area 203 are separated by the switch circuit 430 so that the first area 201 may be operated at the first refresh rate, and the second area 203 may be operated at the second refresh rate. The operation 913 is identical or similar to the operation 707 of FIG. 7 and thus a detailed description thereof may be omitted.

An example of a case where the first area 201 and the second area 203 are separate has been described with reference to FIG. 9, but the same or similar operations may be applied to even a case where multiple areas (e.g., FIG. 4C or FIG. 6B) are separate.

An operation method of an electronic device according to certain embodiments may include: based on a user interface displayed on a display of the electronic device, generating a first signal configured to have a first refresh rate corresponding to a first area of the display, and a second signal configured to have a second refresh rate corresponding to a second area of the display, and transferring a first signal based on the first refresh rate and a second signal based on the second refresh rate to the display to control the display, wherein the first signal causes the first area to be refreshed at the first refresh rate, the second signal causes the second area to be refreshed at the second refresh rate.

The method may further include, if the first refresh rate and the second refresh rate are different from each other, synchronizing a first scan signal and a first data signal for operating the first area of the display panel according to the first refresh rate, and synchronizing a second scan signal and a second data signal for operating the second area of the display panel according to the second refresh rate.

The method may further include, if at least one switch circuit is further included between the first area and the second area of the display, controlling the at least one switch circuit, based on the first refresh rate and the second refresh rate.

The operating of controlling the at least one switch circuit may include: if the first refresh rate and the second refresh rate are identical to each other, turning on the at least one switch circuit; and if the first refresh rate and the second refresh rate are different from each other, turning off the at least one switch circuit.

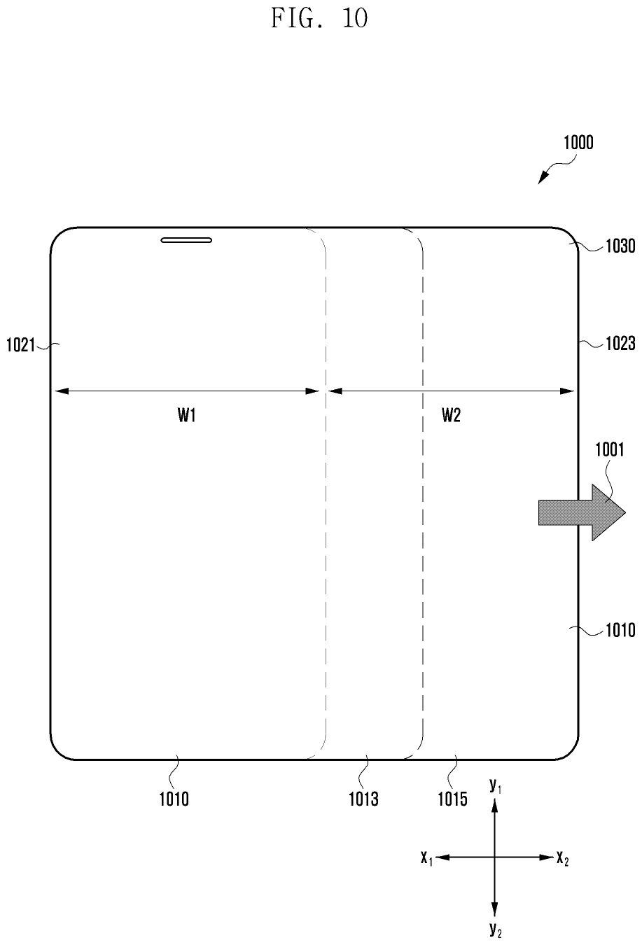

FIG. 10 is a diagram illustrating a configuration for controlling an area-specific refresh rate of a display of a rollable electronic device according to certain embodiments.

Referring to FIG. 10, a rollable electronic device 1000 according to another embodiment (e.g., the electronic device 101 in FIG. 1) may include a housing 1030 having at least a part having a variable length, and a rollable display 1010 (e.g., the display module 160 in FIG. 1) wherein an area or a width visually exposed to the outside is adjusted by a change in the length of the housing 1030.

In another embodiment, the housing 1030 may include a first side member 1021 that is fixed, and a second side member 1023 which is positioned to be opposite to the first side member 1021, and is movable. For example, the first side member 1021 may be disposed and fixed in an x1 direction with respect to the display 1010. For example, the second side member 1023 may be disposed in an x2 direction with respect to the display 1010, and may be moved in the x2 direction in a sliding manner. The display 1010 may have a visually exposed area or width which is variable by the second side member 1023 moving in the x2 direction.

According to an embodiment, the display 1010 may include a flexible substrate, and a visually exposed width of the display may be adjusted, based on a movement of the second side member 1023. For example, as shown by an arrow 1001 in FIG. 10, if the second side member 1023 moves in the x2 direction, the visually exposed width of the display 1010 may be increased. For example, if the second side member 1023 moves in the x1 direction, the visually exposed width of the display 1010 may be decreased.

If it is assumed that, when the distance between the first side member 1021 and the second side member 1023 is shortest, the visually exposed width of the display 1010 is a first width W1, and the maximum width by which the second side member 1023 can move in the x2 distance is a second width W2, the minimum width of the display 1010 is the first width W1, and the maximum width of the display 1010 may be a width W1+W2 obtained by adding up the first width W1 and the second width W2.

It has been described that the first side member 1021 is fixed, and the second side member 1023 can move in the x2 direction. However, the disclosure is not limited thereto, and the first side member 1021 can also move. For example, the first side member 1021 can move in the x1 direction, and the visually exposed width of the display 1010 may be increased in the x1 direction, based on a movement of the first side member 1021.

In the illustrated example, the second side member 1023 has been described to be movable in the x2 direction. However, the disclosure is not limited thereto, and the second side member 1023 can move in a y1 direction or a y2 direction. In this case, the exposed width of the display 1010 may be increased in the y1 direction or the y2 direction, based on a movement of the second side member 1023.

The display 1010 of the rollable electronic device 1000 may be divided into a first area 1011, a second area 1013, and/or a third area 1015 according to a visually exposed width. The first area 1011 may indicate a state where the display 1010 is exposed by the first width W1 (e.g., a partially unrolled state), the second area 1013 may indicate a state where the display 1010 is exposed between the first width W1 and the second width W2, and the third area 1015 may indicate a state where the display 1010 is exposed by a width W1+W2 obtained by adding up the first width W1 and the second width W2 (e.g., an entirely unrolled state). FIG. 10 illustrates three separate areas, but there may be more or fewer than three separate areas.

According to certain embodiments, if only the first area 1011 of the display 1010 is exposed (or unrolled), the rollable electronic device 1000 may determine a refresh rate, based on a user interface displayed on the first area 1011. Alternatively, if the first area 1011 and the second area 1013 of the display 1010 are exposed, the rollable electronic device 1000 may operate the first area 1011 and the second area 1013 at the same or different refresh rates. The rollable electronic device 1000 may determine a first refresh rate corresponding to the first area 1011 or a second refresh rate corresponding to the second area 1013, based on a user interface displayed on the first area 1011 and the second area 1013. An operation of separating two areas and controlling refresh rates has been sufficiently described with reference to FIG. 3A to FIG. 3C, and thus a detailed description may be omitted. Alternatively, if the first area 1011 to the third area 1015 of the display 1010 are exposed, the rollable electronic device 1000 may operate the first area 1011, the second area 1013, and the third area 1015 at the same or different refresh rates. The rollable electronic device 1000 may determine a first refresh rate corresponding to the first area 1011, a second refresh rate corresponding to the second area 1013, or a third refresh rate corresponding to the third area 1015, based on a user interface displayed on the first area 1011 to the third area 1015. An operation of separating three areas and controlling refresh rates has been sufficiently described with reference to FIG. 4B, and thus a detailed description may be omitted.

According to certain embodiments, the rollable electronic device 1000 may include a first switch circuit between scan lines extending to the first area 1011 and the second area 1013, and include a second switch circuit between scan lines extending to the second area 1013 and the third area 1015. The first switch circuit and the second switch circuit may be arranged in the horizontal direction to separate the first area 1011, the second area 1013, and/or the third area 1015. The rollable electronic device 1000 may control the first switch circuit or the second switch circuit, based on an unrolled state of the display 1010. For example, in a case where the first area 1011 to the third area 1015 are operated at the same refresh rate, the rollable electronic device 1000 may turn on the first switch circuit and the second switch circuit. In a case where the first area 1011 and the second area 1013 are operated at different refresh rates, the rollable electronic device 1000 may turn off the first switch circuit. Alternatively, in a case where the first area 1011, the second area 1013, or the third area 1015 are operated at different refresh rates, the rollable electronic device 1000 may turn off the first switch circuit and the second switch circuit. The rollable electronic device 1000 may turn on or off the first switch circuit and the second switch circuit, based on a user interface displayed on the first area 1011 to the third area 1015.

Certain embodiments of the disclosure described and shown in the specification and the drawings have presented specific examples in order to easily explain the technical contents of the disclosure and help understanding of the disclosure, and are not intended to limit the scope of the disclosure. Therefore, the scope of the disclosure should be construed to include, in addition to the embodiments disclosed herein, all changes and modifications that are derived based on the technical idea of the disclosure.

1. An electronic device comprising:
a display;
a memory; and
a processor operatively connected to the display and the memory,
wherein the processor is configured to:
based on a user interface displayed on the display, determine a first refresh rate for a first area of the display, and a second refresh rate for a second area of the display; and
transfer a first signal based on the first refresh rate and a second signal based on the second refresh rate to the display; and
wherein the first signal causes the first area to be refreshed at the first refresh rate, the second signal causes the second area to be refreshed at the second refresh rate

2. The electronic device of claim 1, wherein the display comprises a display driver integrated circuit and a display panel, and
wherein the display driver integrated circuit is configured to operate the display panel, based on the first signal and the second signal.

3. The electronic device of claim 2, wherein the processor is configured to transfer the first signal to the display driver integrated circuit through a first interface, and transfer the second signal thereto through a second interface.

4. The electronic device of claim 2, wherein when the first refresh rate and the second refresh rate are different from each other, the display driver integrated circuit is configured to synchronize a signal transmitted to the first area of the display panel according to the first refresh rate and synchronize a signal transmitted to the second area of the display panel according to the second refresh rate.

5. The electronic device of claim 2, wherein when the first refresh rate and the second refresh rate are different from each other, the display driver integrated circuit is configured to synchronize a first scan signal and a first data signal for operating the first area of the display panel according to the first refresh rate, and synchronize a second scan signal and a second data signal for operating the second area of the display panel according to the second refresh rate.

6. The electronic device of claim 2, wherein when the first refresh rate and the second refresh rate are different from each other, the display driver integrated circuit is configured to synchronize a first scan signal and a first data signal for operating the first area of the display panel according to the first refresh rate, and change the synchronized signals to synchronize a second scan signal and a second data signal for operating the second area of the display panel according to the second refresh rate.

7. The electronic device of claim 1, further comprising at least one switch circuit disposed in a scan line between the first area and the second area for operation of the display,
wherein the processor is configured to control the at least one switch circuit, based on the first refresh rate and the second refresh rate.

8. The electronic device of claim 7, wherein the processor is configured to:
when the first refresh rate and the second refresh rate are the same, turn on the at least one switch circuit; and
when the first refresh rate and the second refresh rate are different from each other, turn off the at least one switch circuit.

9. A display device comprising:
a display panel; and
a display driver integrated circuit including a driver circuit electrically connected to the display panel,
wherein the driver circuit comprises:
a driver electrically connected to the display panel;
a first synchronization module configured to synchronize a signal transmitted to the driver circuit according to a first refresh rate for a first area of the display panel; and
a second synchronization module configured to synchronize a signal transmitted to the driver circuit according to a second refresh rate for a second area of the display panel.

10. The display device of claim 9, wherein the driver comprises:
a gate driver configured to operate a scan line connected to multiple pixels included in the display panel, transmit a first scan signal corresponding to the first area of the display panel, and transmit a second scan signal corresponding to the second area of the display panel; and
a source driver configured to operate a data line connected to the pixels of the display panel, transmit a first data signal so as to correspond to the first area of the display panel, and transmit a second data signal so as to correspond to the second area of the display panel.

11. The display device of claim 10, wherein the first synchronization module is configured to synchronize the first scan signal and the first data signal for operating the first area of the display panel according to the first refresh rate, and
wherein the second synchronization module is configured to synchronize the second scan signal and the second data signal for operating the second area of the display panel according to the second refresh rate.

12. The display device of claim 10, wherein the first synchronization module is configured to synchronize the first scan signal and the first data signal for operating the first area of the display panel according to the first refresh rate, and
wherein the second synchronization module is configured to change the signals synchronized by the first synchronization module and to synchronize the second scan signal and the second data signal.

13. The display device of claim 9, wherein the display panel further comprises at least one switch circuit disposed in a scan line between the first area and the second area for operation of the display panel, and
wherein the display driver integrated circuit is configured to control the at least one switch circuit, based on the first refresh rate and the second refresh rate.

14. The display device of claim 13, wherein the display driver integrated circuit is configured to:
when the first refresh rate and the second refresh rate are equal to each other, turn on the at least one switch circuit; and
when the first refresh rate and the second refresh rate are different from each other, turn off the at least one switch circuit.

15. An operation method of an electronic device, the method comprising:
based on a user interface displayed on a display of the electronic device, determining a first refresh rate for a first area of the display, and a second refresh rate for a second area of the display; and
transferring a first signal based on the first refresh rate and a second signal based on the second refresh rate to the display to control the display;
wherein the first signal causes the first area to be refreshed at the first refresh rate, the second signal causes the second area to be refreshed at the second refresh rate.
